(19) United States
(12) Patent Application Publication
(10) Pub. No.: US 2008/0236393 A1
(43) Pub. Date: Oct. 2, 2008

(54) FILTER ASSEMBLY

(75) Inventors: Deborah H. Heller, Raleigh, NC (US); Jeffrey R. McClellan, Raleigh, NC (US); James Xavier Torok, Raleigh, NC (US)

Correspondence Address: FOGG & POWERS LLC, 10 SOUTH FIFTH STREET, SUITE 1000, MINNEAPOLIS, MN, 55402, US

(73) Assignee: ADC DSL SYSTEMS, INC., Eden Prairie, MN (US)

(21) Appl. No.: 11/692,436

(22) Filed: Mar. 28, 2007

(51) Int. Cl. B01D 35/30; B01D 46/42; B01D 50/00; B23P 17/00; B65B 7/28

(52) U.S. Cl. 95/273; 156/69; 210/232; 29/422; 55/385.6

(57) ABSTRACT

A filter assembly comprising a cover plate and a filter support. The filter support includes a length extending perpendicularly from an edge of the cover plate, a first edge and a second edge defining a height, a first U-shaped filter support extending from the first edge and a second U-shaped filter support extending from the second edge. The first U-shaped filter support and the second U-shaped filter support are configured to hold a filter there-between.

This application is related to U.S. patent applications Ser. No. ______ (Attorney Docket No. 100.813) having a title of “CROSSBAR SWITCH” (also referred to here as the “100.813 Application”) filed on the same date herewith.

This application is also related to U.S. patent applications Ser. No. ______ , (Attorney Docket No. 100.815) having a title of “FAN MODULE” (also referred to here as the “100.815 Application”) filed on the same date herewith.

This application is also related to U.S. patent applications Ser. No. ______ , (Attorney Docket No. 100.816) having a title of “AN APPARATUS FOR COOLING ELECTRONICS” (also referred to here as the “100.816 Application”) filed on the same date herewith.

The 100.813 Application, the 100.815 Application, and the 100.816 Application are incorporated herein by reference.

### BACKGROUND

Equipment, such as the crossbar switch described in the related application having Attorney Docket No. 100.813, require cooling to keep temperature sensitive electronic and/or optical devices within desired temperature range. In some equipment, the devices in the equipment require relatively clean environment. If dirt or particles enter the equipment via the cooling system, a ill-placed particle can short out an electronic device or block an optical beam in an optical device or optical system within the equipment.

### SUMMARY

In one embodiment, a filter assembly comprising a cover plate and a filter support. The filter support includes a length extending perpendicularly from an edge of the cover plate, a first edge and a second edge defining a height, a first U-shaped filter support extending from the first edge and a second U-shaped filter support extending from the second edge. The first U-shaped filter support and the second U-shaped filter support are configured to hold a filter there-between.

In another embodiment, a telecommunications equipment system that includes a chassis to house telecommunications equipment, a filter assembly having a filter support, and a filter. The filter support is configured to fit within the chassis in the path of an airflow. The filter is configured to fit within the filter support extending the majority the length of the chassis, so that air in the path of the airflow is filtered by the filter.

In yet another embodiment, a method of manufacturing a filter assembly comprising forming a cover plate and forming a filter support connected to and extending perpendicularly from a face of the cover plate. The filter assembly includes a first U-shaped filter support and a second U-shaped filter support.

In yet another embodiment, a method of using a telecommunications equipment system comprising inserting a filter support of a filter assembly into a filter-assembly slot in a chassis housing telecommunications equipment, removably attaching a cover plate to the chassis, operating the equipment housed in the chassis, detaching the cover plate from the chassis while the equipment is operating, and removing the filter and the filter support from the filter-assembly slot. The filter held in the filter support is positioned in the filter-assembly slot.

### DRAWINGS

FIGS. 1A-1D show one embodiment of a filter assembly from four views.

FIGS. 2A-2C show an elevation, top view and side view of one embodiment of a filter configured to fit in a filter assembly.

FIGS. 3A and 3B show one embodiment of the filter partially inserted and completely inserted within the filter assembly, respectively.

FIGS. 4A and 4B show two oblique views of one embodiment of a telecommunications equipment system in which the filter assembly is partially inserted into a filter-assembly slot.

FIG. 5 is a flow diagram of one embodiment of a method of using a telecommunications equipment system in accordance with the present invention.

FIG. 6 is a flow diagram of one embodiment of a method of manufacturing a filter assembly in accordance with the present invention.

FIG. 7 is a flow diagram of one embodiment of a method of manufacturing a filter assembly in accordance with the present invention.

FIG. 8 is a flow diagram of one embodiment of a method of manufacturing a filter assembly in accordance with the present invention.

FIG. 9 is a plan view of one embodiment of a first section connected to a second section.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

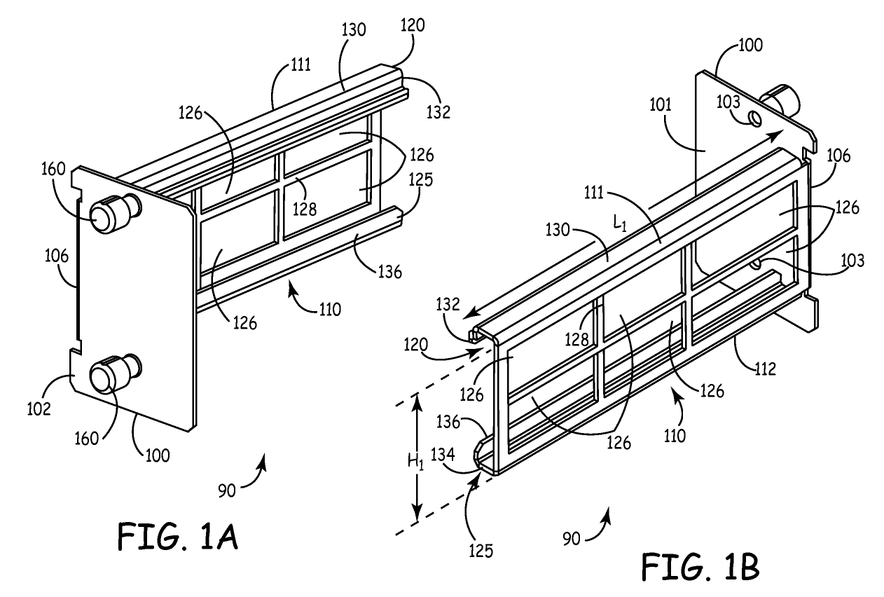

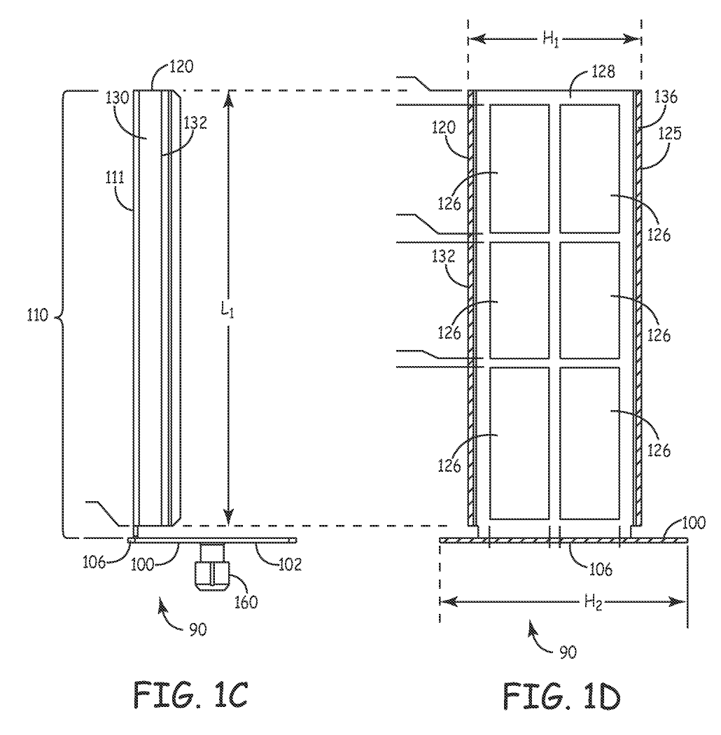

FIGS. 1A-1D show one embodiment of a filter assembly from four views. FIGS. 1A and 1B shows one embodiment of a filter assembly 90 from two oblique views. The filter assembly 90 includes a cover plate 100 and a filter support 110. FIG. 1A shows the filter assembly 90 with a view of the front face 102 of the cover plate 100. FIG. 1B shows the filter assembly 90 with a view of the back face 101 of the cover plate 100. FIG. 1C shows a top view of the filter assembly 90. FIG. 1D shows a side view of the filter assembly 90.

The filter support 110 has a length L₁ extending perpendicularly from an edge 106 of the cover plate 100, a first edge 111 and a second edge 112, a first U-shaped filter support 120 and a second U-shaped filter support 125. The first edge 111 and the second edge 112 define a height Hi. The filter support 110 has at least one opening 126 positioned between the first edge 111 and the second edge 112 to permit air flow through a filter 140 (not shown in FIGS. 1A-1D) held by the first U-shaped filter support 120 and the second U-shaped filter support 125. The openings 126 are in the back section 128 that extends between the first edge 111 and the second edge 112.

The first U-shaped filter support 120 extends from the first edge 111. The ledge 130 or bottom of the U-shape extends from the first edge 11 1 to the lip 132 which is one side of the U-shape. The lip 132 is perpendicular to the ledge 130 and extends in the direction toward the second U-shaped filter support 125. Thus, the U-shape that holds one edge of the filter (not shown in FIGS. 1A-1D) includes the lip 132, the ledge 130 and the back section 128 adjacent to the first edge 111.

The second U-shaped filter support 125 extends from the second edge 112. The ledge 134 or bottom of the U-shape extends from the second edge 112 to the lip 136 or side of the U-shape. The lip 136 is perpendicular to the ledge 134 and extends in the direction toward the first U-shaped filter support 120. Thus, the U-shape that holds one edge of the filter (not shown in FIGS. 1A-1D) includes the lip 136, the ledge 134 and the back section 128 adjacent to the second edge 112.

The first U-shaped filter support 120 and the second U-shaped filter support 125 are configured to hold a filter 140 within the U-shaped sections of the first U-shaped filter support 120 and the second U-shaped filter support 125.

The cover plate 100 includes at least one hole 103 (FIG. 1B). The holes 103, also referred to here as screw holes 103, are configured to accept a screw 160. In one implementation of this embodiment, there are two holes 103.

A screw 160, also referred to herein as a thumb screw 160, is shown screwed into the hole 103 till flush with the front face 102 of the cover plate 100 (FIG. 1C). As seen from the top view of this exemplary filter assembly 90, the edge 106 extends along a portion of edge 106, which is on the right hand side of the cover plate 100.

In one implementation of this embodiment, the height H₁ of the filter support 110 is less than the height H₂ of the cover plate 100 (FIG. 1D). In this case, the length of the edge 106 that connects the filter support 110 to the cover plate 100 is less than or equal to the height H₁ (FIG. 1D). In one implementation of this embodiment, the height H₂ of the cover plate 100 is 3.3 inches and the height H₁ of the filter support 110 is 1.79 inches. In another implementation of this embodiment, the depth of the U-shaped groove (i.e., the length of the lips 132 and 136) is 0.25 inches and the width of the bottom of the U-shaped groove (i.e., the length of the ledge 130 and 134) is 0.28 inches. In yet another implementation of this embodiment, the filter assembly 90 is made of metal, such as aluminum.

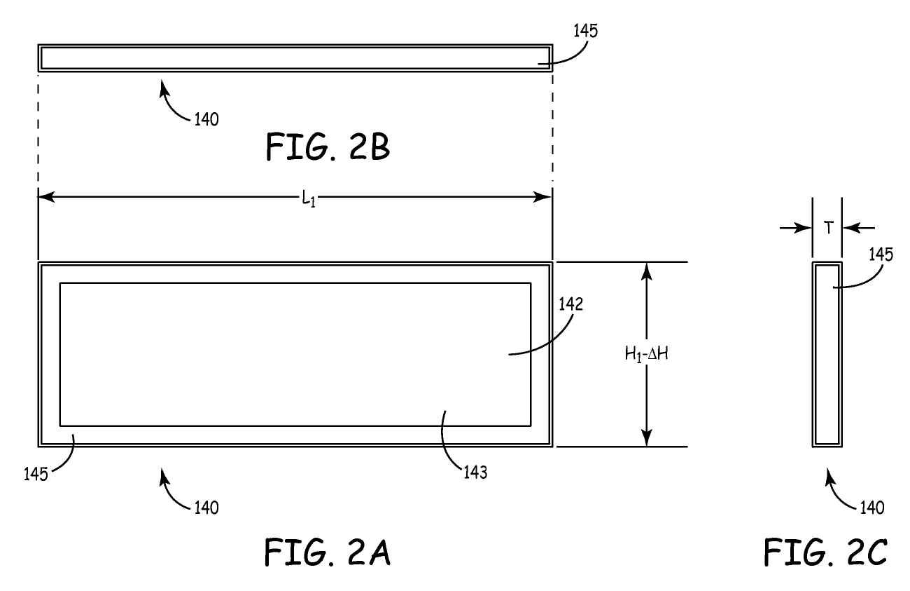

FIGS. 2A-2C show an elevation, top view and side view, respectively, of one embodiment of a filter 140 configured to fit in a filter assembly 90. The filter 140 is rectangular with a length L₁ and a height (H₁-ΔH), where ΔH is less than one-half of the length of the lip 132 or the lip 136. The filter 140 is configured to fit within the filter support 110 and to extend the majority of the length of the interior portion of the chassis 200, wherein air in the path of the airflow is filtered by the filter 140. The filter 140 is held by the first U-shaped filter support 120 and the second U-shaped filter support 125. In operation, the filter assembly 90 with a filter 140 held between the first U-shaped filter support 120 and the second U-shaped filter support 125 permits air flow through the filter 140. The front face 143 of the filter material 142 is shown in FIG. 2A. In one implementation of this embodiment, the front face 143 and the back face are identical.

The filter 140 includes a filter frame 145 and filter material 142. The filter frame 145 surrounds the perimeter of the filter material 142. The filter frame 145 completely covers the edges of the filter 140 and extends partially over the front face 143 and the back face (not shown) of the filter material 142 to hold the filter material within the filter frame 145. The thickness T of the filter frame 145 is slightly less than the length of the ledges 130 and 134. In one implementation of this embodiment, the filter material is 0.25 inch thick quadrofoam. In another implementation of this embodiment, the filter frame 145 is a metal, plastic, or fiber glass. In yet another implementation of this embodiment, the filter frame 145 is 0.25 inches thick aluminum. In yet another implementation of this embodiment, the filter frame 145 extends 0.25 inches over the front face 143 and opposing back face of the filter material 142.

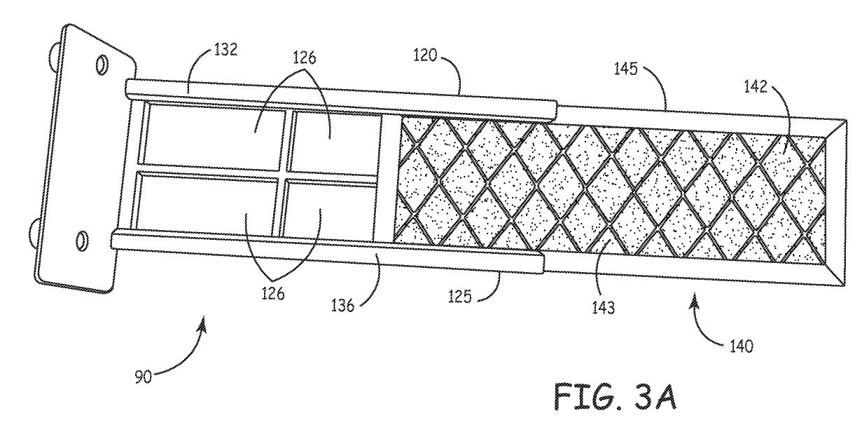

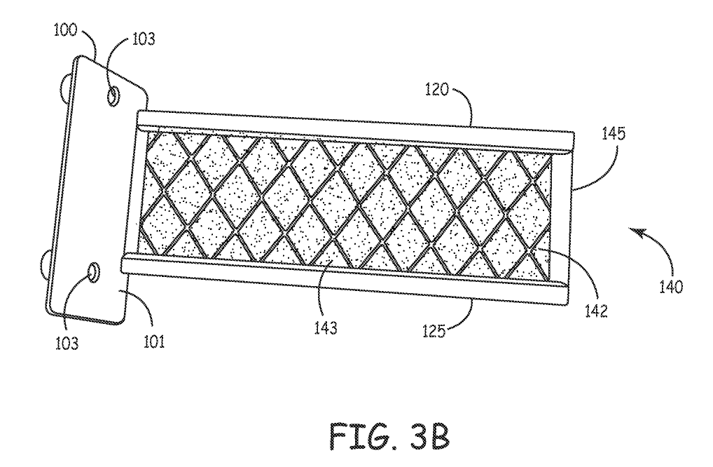

FIGS. 3A and 3B show one embodiment of the filter partially inserted and completely inserted within the filter assembly, respectively. Since the length L₁ of the filter 140 is equal to the length L₁ of the filter support 110 and the height (H₁-ΔH) of the filter 140 is slightly less than height H₁ of the filter support 110 and the thickness T of the filter frame 145 is slightly less than the length of the ledges 130 and 134 (i.e., or bottoms of the U-shapes), the edges of the filter frame 145 that have the dimension L₁ fit within the first U-shaped filter support 120 and the second U-shaped filter support 125. The filter 140 can be pushed into the filter assembly 90 (FIG. 3A) until the filter 140 is completely held within the filter assembly 90.

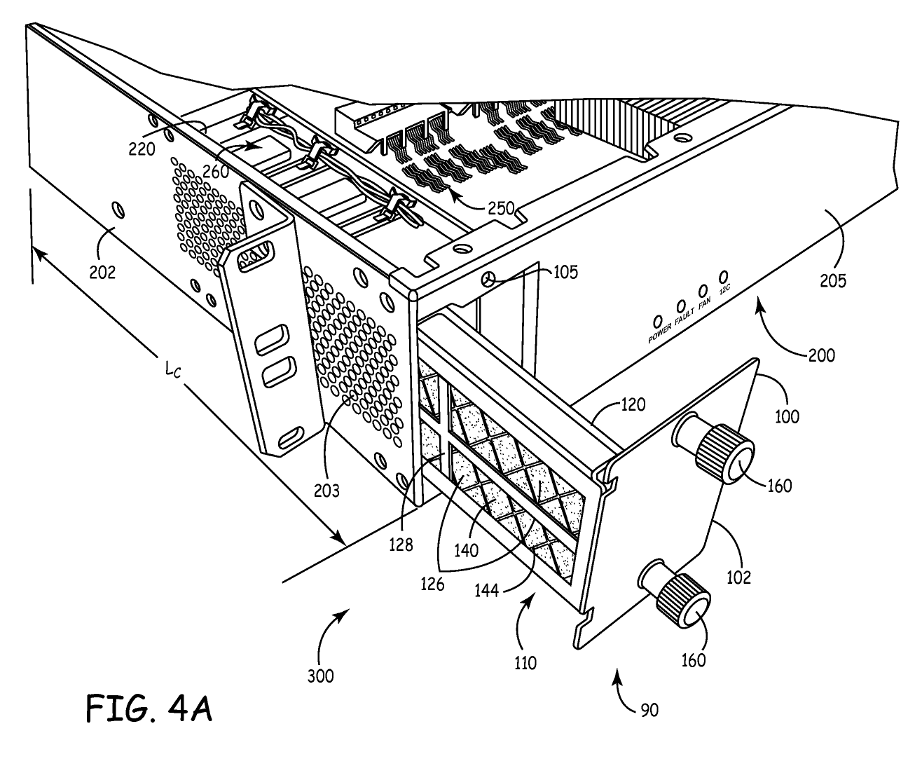

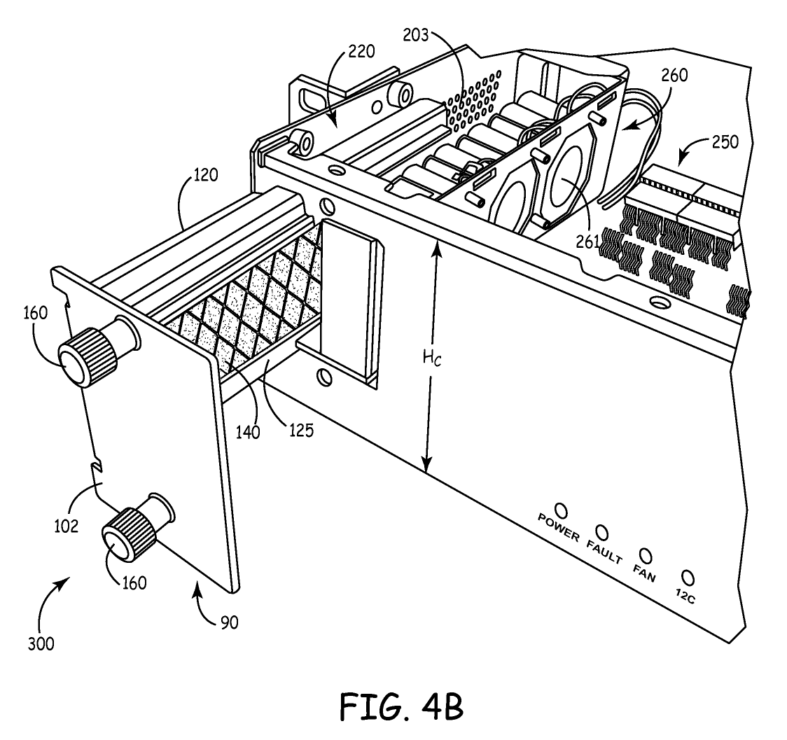

FIGS. 4A and 4B show two oblique views of one embodiment of a telecommunications equipment system 300 in which the filter assembly 90 is partially inserted into a filter-assembly slot 220. The telecommunications equipment system 300 includes a chassis 200 to house telecommunications equipment 250, a fan system 260, and a filter assembly 90 holding a filter 140, as described above with reference to FIGS. 1A-1D and FIGS. 2A-2B. The filter assembly 90 fits in the chassis 200 within a filter-assembly slot 220 in the path of the airflow. The filter 140 fits within the filter support 110 and extends a majority of the length L_{c} (FIG. 4A) and height H_{c} (FIG. 4B) of the chassis 200.

The chassis 200 houses the fan system 260 and includes a partially opened exterior surface 202 that forms one side of the filter-assembly slot 220. The fan system 260 forms the other side of the filter-assembly slot 220. The fan system 260 generates the airflow between the partially opened exterior surface 202 and at least one fan 261 in the fan system 260. At least a portion of the path of airflow is between at least one opening 203 in the partially opened exterior surface 202 and the fan 261. Air in the path of the airflow is filtered by the filter 140 when the filter assembly 90 is completely inserted into the filter-assembly slot 220 and the fan system 260 is operational.

Each screw 160 is used to attach the cover plate 100 to the equipment chassis 200 when the filter support is positioned in a filter-assembly slot 220 within the equipment chassis 200. The screws 160 are screwed into the screw holes 105 (one visible in FIG. 4A) to secure the cover plate 100 to the front surface 205 of the chassis 200. When the cover plate 100 is flush with a portion of the front surface 205, the filter assembly 90 is automatically positioned within a filter-assembly slot 220 in the path of the airflow.

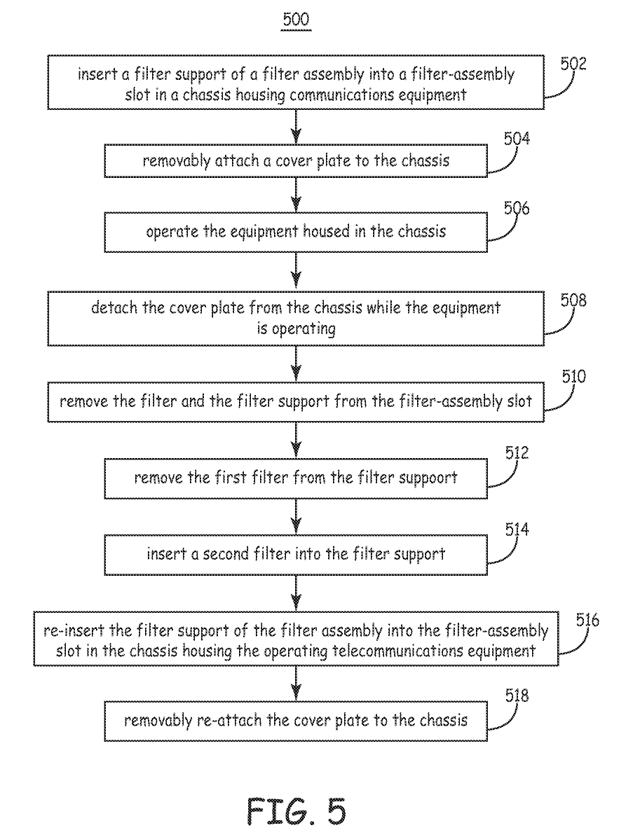

The filter assembly 90 can be removed from the chassis 200 while the telecommunications equipment 250 is operational. In one implementation of this embodiment, the filter assembly 90 is removed from the chassis 200 and a new filter 140 is inserted into the filter support 110. FIG. 5 is a flow diagram of one embodiment of a method 500 of using a telecommunications equipment system in accordance with the present invention. Method 500 is described with reference to the filter assembly 90 of FIGS. 1A-1D and the telecommunications equipment system of FIGS. 4A and 4B.

At block 502, a filter support of a filter assembly is inserted into a filter-assembly slot in a chassis housing telecommunications equipment. In one implementation of this embodiment, the filter support 110 of a filter assembly 90 is inserted into a filter-assembly slot 220 in a chassis 200 housing telecommunications equipment so that the first filter 140 held in the filter support 110 is positioned in the filter-assembly slot 220. At block 504, a cover plate is removably attached to the chassis. In one implementation of this embodiment, a cover plate 100 is removably attached to the chassis 200 by screwing the thumbscrews 160 through the holes 103 into the threaded holes 105 in the front face 205 of the chassis 200.

At block 506, the equipment housed in the chassis is operated. In one implementation of this embodiment, the telecommunications equipment 250 housed in the chassis 200 is operated. At block 508, the cover plate is detached from the chassis while the equipment is operating. In one implementation of this embodiment, the cover plate 100 is detached from the chassis 200 while the telecommunications equipment 250 is operating. The cover plate 102 is detached by unscrewing the thumbscrews 160 so that the cover plate 100 is no longer attached to the chassis 200.

At block 510, the filter and the filter support are removed from the filter-assembly slot. In one implementation of this embodiment, the filter 140 and the filter support 110 are removed from the filter-assembly slot 220 by pulling the cover plate 100 away from the front face 205 of the chassis 200.

At block 512, the first filter is removed from the filter support. In one implementation of this embodiment, the first filter 140 is removed from the filter support 110. At block 514, a second filter is inserted into the filter support 110. In one implementation of this embodiment, a second filter, similar to filter 140, is inserted into the filter support 110.

At block 516, the filter support of the filter assembly is re-inserted into the filter-assembly slot in the chassis housing the operating telecommunications equipment so that the second filter is positioned in the filter-assembly slot. In one implementation of this embodiment, the filter support 110 of the filter assembly 90 is re-inserted into the filter-assembly slot 220 in the chassis 200 housing the operating telecommunications equipment 250. The second filter is positioned in the filter-assembly slot 220 in the path of the airflow. At block 518, the cover plate is removably re-attached to the chassis. In one implementation of this embodiment, the cover plate 100 is removably re-attached to the chassis 200 using the screws 160 to attach the cover plate 100 to the front face 205 of the chassis 200.

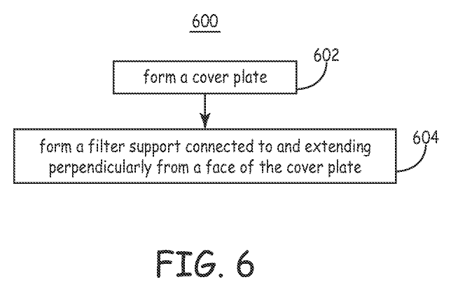

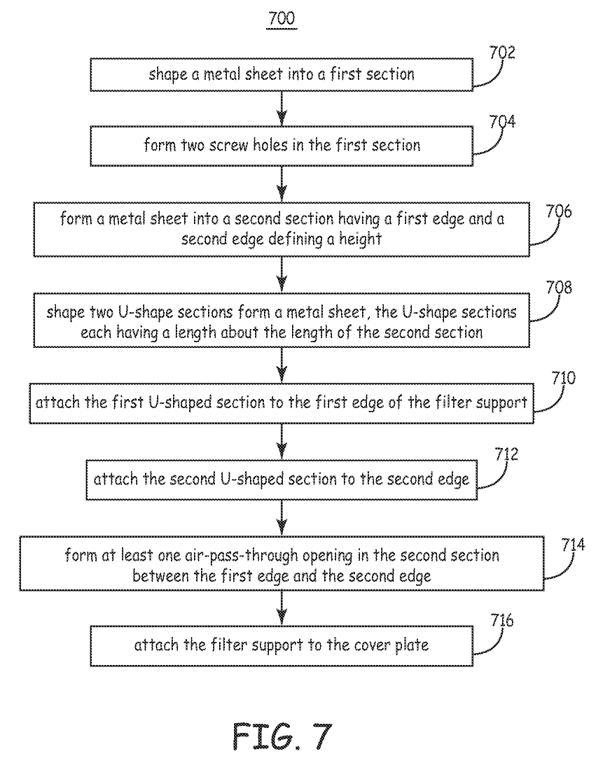

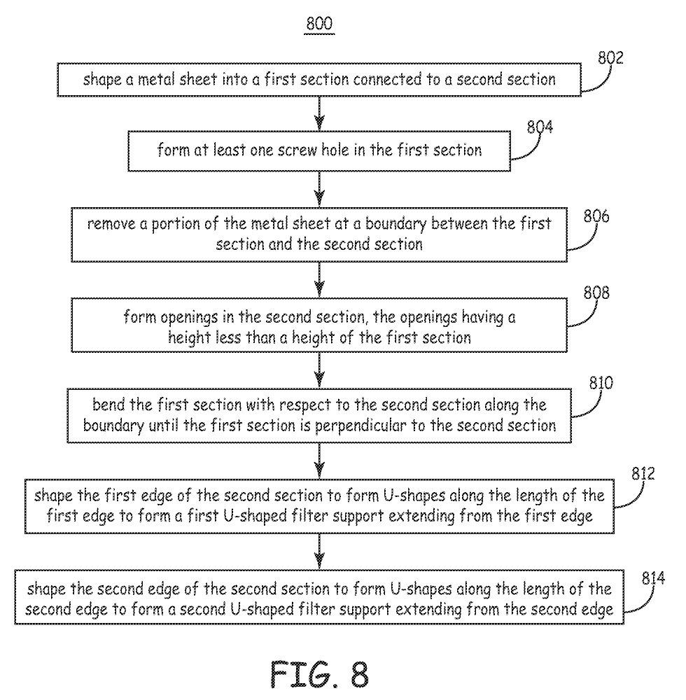

FIG. 6 is a flow diagram of one embodiment of a method 600 of manufacturing a filter assembly 90 in accordance with the present invention. Method 600 is described with reference to the filter assembly 90 of FIGS. 1A-1D and the telecommunications equipment system 300 of FIGS. 4A and 4B. At block 602, a cover plate is formed. In one implementation of this embodiment, the cover plate 100 is formed. At block 604, a filter support connected to and extending perpendicularly from a face of the cover plate is formed. In one implementation of this embodiment, a filter support 110 connected to and extending perpendicularly from a back face 101 of the cover plate 100 is formed. The description of methods 700 and 800 of FIGS. 7 and 8, respectively, describe embodiments of how to implement blocks 602 and 604.

FIG. 7 is a flow diagram of one embodiment of a method 700 of manufacturing a filter assembly 90 in accordance with the present invention. Method 700 is described with reference to the filter assembly 90 of FIGS. 1A-1D and the telecommunications equipment system of FIGS. 4A and 4B.

At block 702, a metal sheet is shaped into a first section. At block 704, two screw holes 103 are formed in the first section. In one implementation of this embodiment, two screw holes 103 are drilled in the first section. In another implementation of this embodiment, two screw holes 103 are etched through in the first section. In yet another implementation of this embodiment, two screw holes 103 are punched through the first section. In yet another implementation of this embodiment, two screw holes 103 are cut through the first section. In yet another implementation of this embodiment, two screw holes 103 are formed in the first section.

At block 706, a metal sheet is formed into a second section having a first edge and a second edge defining a height. In one implementation of this embodiment, a metal sheet is formed into a second section having a first edge 111 and a second edge 112 defining a height H₁.

At block 708, two U-shape sections are shaped from a metal sheet. The U-shape sections each have a length about the length of the second section. At block 710, the first U-shaped section is attached to the first edge of the filter support. In one implementation of this embodiment, the first U-shaped section is attached to the first edge 111 of the filter support 110.

At block 712, the second U-shaped section is attached to the second edge so that the U-shapes are open to each other. In one implementation of this embodiment, a second U-shaped section 125 is attached to the second edge 112 so that the U-shapes 120 and 125 are open to each other. In this manner, a first U-shaped filter support 120 extending from the first edge 111 is formed and a second U-shaped filter support 125 extending from the second edge 112 is formed.

At block 714, at least one air-pass-through opening is formed in the second section between the first edge 111 and the second edge 112. In one implementation of this embodiment, six air-pass-through openings 126 are formed in the second section 128 between the first edge 111 and the second edge 112.

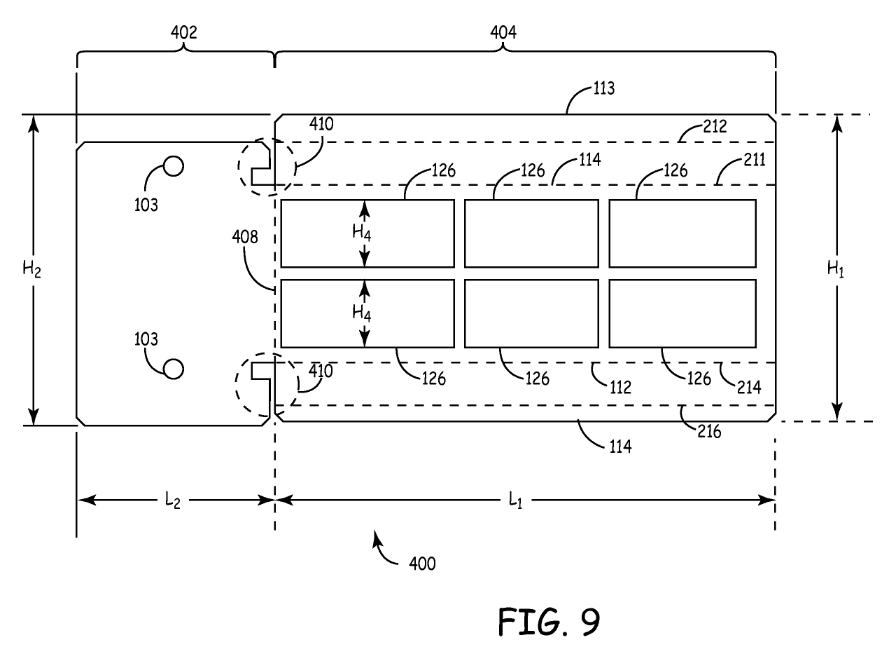

FIG. 8 is a flow diagram of one embodiment of a method 800 of manufacturing a filter assembly 90 in accordance with the present invention. Method 800 is described with reference to the filter assembly 90 of FIGS. 1A-D and the telecommunications equipment system of FIGS. 4A and 4B and FIG. 9. FIG. 9 is a plan view of one embodiment of a first section 402 connected to a second section 404.

The cover plate 100 is formed according to the process described with respect to blocks 802 and 804. At block 802, a sheet is shaped into a first section and a connected second section. The first section and a second section share a boundary. In one implementation of this embodiment, the sheet 400 of FIG. 9 is shaped into the first section 402 and the second section 404 at a shared a boundary 408.

At block 804, at least one screw hole 103 is formed in the first section. In one implementation of this embodiment, two screw holes 103 are formed in the first section 402 by drilling the holes 103 in the metal plate 400. In yet another implementation of this embodiment, two screw holes 103 are punched through the first section. In yet another implementation of this embodiment, two screw holes 103 are cut through the first section. In yet another implementation of this embodiment, two screw holes 103 are formed in the first section.

At block 806, a portion of the metal sheet is removed at the boundary between the first section and the second section. In one implementation of this embodiment, portions encircled by the dashed circles 410 in FIG. 9 are removed at the boundary 408 between the first section 402 and the second section 404. The remaining boundary 408 has a height less than the height H₁ and less than the height H₂. In one implementation of this embodiment, block 806 is optional.

The filter support 110 is formed according to the process described with respect to blocks 808 through 814. At block 808, openings are formed in the second section. The openings have a height that is less than a height of the first section. In the embodiment shown in FIG. 9, six openings 126 are formed in the second section 404. The openings 126 have a height H₄ that is less than the height H₂ of the first section 402.

At block 810, the first section is bent with respect to the second section along the boundary until the first section is perpendicular to the second section. In one implementation of this embodiment, the first section 402 is bent with respect to the second section 404 along the boundary 408 until the first section 402 is perpendicular to the second section 404 and the projecting out of the plane in which the second section 404 lies. The removal of the portions 410 makes the bending of the first portion 402 with respect to the second portion 404 easier since the remaining boundary 408 has less material to bend.

At block 812, the first edge of the second section is shaped to form U-shapes along the length of the first edge in order to form the first U-shaped filter support extending from the first edge. In one implementation of this embodiment shown in FIG. 9, the second section 404 is bent along two dashed lines 211 and 212 to form a U-shape in the material between the first edge 111 and the edge 113 of the second section 404. The dashed line 211 is the same as dashed line 111 that represents the first edge 111. For example, the second section 404 is bent along the dashed line 211 so that the material between the dashed line 211 and the edge 113 is perpendicular to projecting out of the plane in which the openings 126 lie.

Then the second section 404 is bent along the dashed line 212 so that the material between the dashed line 212 and the edge 113 is parallel to the plane in which the openings 126 lie. The material between the dashed line 212 and the edge 113 is offset from the plane in which the openings 126 lie by the distance between the dashed line 211 and dashed line 212. The dashed line 211 is now the edge 111 as seen in FIGS. 1A-1C. The material between the dashed line 212 and the edge 113 is the lip 132. The material between the dashed line 211 and dashed line 212 is the ledge 130. In this manner the first U-shaped filter support 120 extending from the first edge 111 is formed.

At block 814, the second edge of the second section is shaped to form U-shapes along the length of the second edge in order to form the second U-shaped filter support extending from the first edge. The U-shapes are open to each other. In one implementation of this embodiment shown in FIG. 9, the second section 404 is bent along two dashed lines 214 and 216 to form a second U-shape in the material between the second edge 112 and the edge 114 of the second section 404. The second U-shape opens towards the first U-shape that is formed in the material between the first edge 111 and the edge 113. The dashed line 214 is the same as dashed line 112 that represents the second edge 112 shown in FIG. 1B. For example, the second section 404 is bent along the dashed line 214 so that the material between the dashed line 214 and the edge 114 is perpendicular to and projecting out of the plane in which the openings 126 lie.

Then the second section 404 is bent along the dashed line 216 towards the edge 113 so that the material between the dashed line 216 and the edge 114 is parallel to the plane in which the openings 126 lie. The material between the dashed line 216 and the second edge 114 is offset from the plane in which the openings 126 lie by the distance between the dashed line 214 and dashed line 216. The dashed line 214 is now the second edge 112 as seen in FIGS. 1B-1C. The material between the dashed line 216 and the edge 114 is the lip 136. The material between the dashed line 214 and dashed line 216 is the ledge 134. In this manner the second U-shaped filter support 125 extending from the second edge 112 is formed.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A filter assembly comprising:
a cover plate; and
a filter support, the filter support having:
a length extending perpendicularly from an edge of the cover plate;
a first edge and a second edge defining a height;
a first U-shaped filter support extending from the first edge; and
a second U-shaped filter support extending from the second edge, wherein the first U-shaped filter support and the second U-shaped filter support are configured to hold a filter there-between.

2. The filter assembly of claim 1, wherein the cover plate comprises:
at least one hole, each hole configured to accept a screw, wherein each screw is operable to attach the cover plate to an equipment chassis when the filter support is positioned in a filter-assembly slot within the equipment chassis.

3. The filter assembly of claim 1, the filter support having at least one opening positioned between the first and the second edges to permit air flow through a filter held by the first U-shaped filter support and the second U-shaped filter support.

4. A telecommunications equipment system comprising:
a chassis to house telecommunications equipment;
a filter assembly having a filter support, the filter support configured to fit within the chassis in the path of an airflow; and
a filter configured to fit within the filter support extending the majority the length of the chassis, wherein air in the path of the airflow is filtered by the filter.

5. The telecommunications equipment system of claim 4, further comprising:
a partially opened exterior surface of the chassis;
a fan system within the chassis to generate the airflow between the partially opened exterior surface and at least one fan in the fan system; and
a filter-assembly slot between at least one opening in the partially opened exterior surface and the fan, wherein the filter support is configured to fit within the chassis in the filter-assembly slot.

6. The telecommunications equipment system of claim 5, the filter assembly further comprising:
a cover plate, wherein the filter support has a length extending perpendicularly from the cover plate.

7. The telecommunications equipment system of claim 6, wherein the cover plate further comprises:
at least one hole, each hole configured to accept a screw, wherein each screw is operable to attach the cover plate to the chassis when the filter support is positioned in the filter-assembly slot.

8. The telecommunications equipment system of claim 5, wherein the filter support comprises:
a first edge and a second edge defining a height;
a first U-shaped filter support extending from the first edge; and
a second U-shaped filter support extending from the second edge, wherein the first U-shaped filter support and the second U-shaped filter support are configured to hold the filter there-between; and
at least one opening between the first edge and the second edge to permit air flow through the filter held by the first U-shaped filter support and the second U-shaped filter support.

9. The telecommunications equipment system of claim 8, wherein, when the filter assembly is positioned within the chassis, the at least one opening between the first edge and the second edge and the partially opened exterior surface of the chassis are both within the path of the airflow.

10. The telecommunications equipment system of claim 9, wherein an area of the at least one opening between the first edge and the second edge is about equal to an area of the partially opened exterior surface of the chassis.

11. The telecommunications equipment system of claim 4, wherein the telecommunications equipment is operable when the filter support is positioned within the chassis, positioned partially within the chassis, and removed from the chassis.

12. A method of manufacturing a filter assembly, the method comprising:
forming a cover plate; and
forming a filter support connected to and extending perpendicularly from a face of the cover plate, the filter assembly including a first U-shaped filter support and a second U-shaped filter support.

13. The method of claim 12, wherein forming the cover plate comprises:
shaping a metal sheet into a first section; and
forming two screw holes in the first section.

14. The method of claim 13, wherein forming the filter support comprises:
forming a metal sheet into a second section having a first edge and a second edge defining a height:
forming a first U-shaped filter support extending from the first edge;
forming a second U-shaped filter support extending from the second edge; and
forming at least one air-pass-through opening in the second section between the first edge and the second edge.

15. The method of claim 14, further comprising:
attaching the filter support to the cover plate, wherein the first U-shaped filter support and the second U-shaped filter support are perpendicular to the cover plate, and wherein the U-shapes in the first U-shaped filter support and the second U-shaped filter support open towards each other.

16. The method of claim 12, wherein forming the cover plate comprises:
shaping a metal sheet into a first section and a second section, wherein the first section and a second section share a boundary;
forming at least one screw hole in the first section, and wherein forming a filter support comprises:
forming openings in the second section, the openings having a height less than a height of the first section; and
bending the first section with respect to the second section along the boundary until the first section is perpendicular to the second section

17. The method of claim 16, wherein forming the cover plate further comprises:
removing a portion of the metal sheet at a boundary between the first section and the second section.

18. The method of claim 16, wherein the second section has a first edge and a second edge, the second edge parallel to the first edge and perpendicular to the boundary, and wherein forming the filter support further comprises:
shaping the first edge of the second section to form U-shapes along the length of the first edge;
shaping the second edge of the second section to form U-shapes along the length of the second edge, wherein the U-shapes are open to each other.

19. The method of claim 16, wherein the second section has a first edge and a second edge parallel to the first edge and perpendicular to the boundary, and wherein forming the filter support further comprises:
shaping two U-shape sections from a metal sheet, the U-shape sections each having a length about the length of the second section;
attaching a first U-shaped section to the first edge of the filter support; and
attaching a second U-shaped section to the second edge, wherein the U-shapes are open to each other.

20. A method of using a telecommunications equipment system, the method comprising:
inserting a filter support of a filter assembly into a filter-assembly slot in a chassis housing telecommunications equipment, wherein a filter held in the filter support is positioned in the filter-assembly slot;
removably attaching a cover plate to the chassis;
operating the equipment housed in the chassis; and
detaching the cover plate from the chassis while the equipment is operating; and
removing the filter and the filter support from the filter-assembly slot.

21. The method of claim 20, wherein the filter is a first filter, the method further comprising:
removing the first filter from the filter support;
inserting a second filter into the filter support;
re-inserting the filter support of the filter assembly into the filter-assembly slot in the chassis housing the operating telecommunications equipment, wherein the second filter is positioned in the filter-assembly slot; and
removably re-attaching the cover plate to the chassis.
